(19) United States
(12) Patent Application Publication
(10) Pub. No.: US 2024/0412300 A1
(43) Pub. Date: Dec. 12, 2024

(54) SYSTEMS AND METHODS FOR MANAGEMENT OF CUSTOMER RELATIONSHIP MANAGEMENT CONTACT ENTRIES

(71) Applicant: JPMORGAN CHASE BANK, N.A., New York, NY (US)

(72) Inventors: Bret GOLDSMITH, Sugarland, TX (US); Joel POTTS, London (GB)

(21) Appl. No.: 18/678,426

(22) Filed: May 30, 2024

Related U.S. Application Data
(60) Provisional application No. 63/507,221, filed on Jun. 9, 2023.

(51) Int. Cl. G06Q 50/00; G06Q 10/107

(52) U.S. Cl. CPC G06Q 50/01; G06Q 10/107

(57) ABSTRACT

Systems and methods for management of customer relationship management contact entries are disclosed. According to one embodiment, a method may include: (1) retrieving, by a computer program, a plurality of contact entries from users within an organization; (2) grouping, by the computer program, the plurality of contact entries into a plurality of contact entry groupings, wherein each contact entry grouping may include at least one common attribute; (3) receiving, by the computer program, a query for one of the users having a contact entry with a target individual; (4) identifying, by the computer program, one of the contact entry groupings for the target individual based on the query; (5) determining, by the computer program, a strength of connection to the target individual for contact entries in the contact entry grouping; and (6) returning, by the computer program, an identification of the user with a highest strength of connection.

### RELATED APPLICATIONS

This application claims the benefit of, and priority to, U.S. Provisional Patent Application Ser. No. 63/507,221, filed Jun. 9, 2023, the disclosure of which is hereby incorporated, by reference, in its entirety.

### BACKGROUND OF THE INVENTION

### 1. Field of the Invention

Embodiments relate to systems and methods for management of customer relationship management contact entries.

### 2. Description of the Related Art

Organizations use customer relationship management (CRM) programs to manage their interactions with their customers. CRM programs log data on customer contact entries and potential customer contact entries to manage, track, and better understand the relationship. This is achieved by maintaining a unique master record for each contact. Based on the information collected, they generate a searchable database of contact entries.

### SUMMARY OF THE INVENTION

Systems and methods for management of customer relationship management contact entries are disclosed. According to one embodiment, a method may include: (1) retrieving, by a computer program, a plurality of contact entries from users within an organization; (2) grouping, by the computer program, the plurality of contact entries into a plurality of contact entry groupings, wherein each contact entry grouping may include at least one common attribute; (3) receiving, by the computer program, a query for one of the users having a contact entry with a target individual; (4) identifying, by the computer program, one of the contact entry groupings for the target individual based on the query; (5) determining, by the computer program, a strength of connection to the target individual for contact entries in the contact entry grouping; and (6) returning, by the computer program, an identification of the user with a highest strength of connection.

In one embodiment, the users may be employees of the organization.

In one embodiment, the common attribute may include a name, a phone number, and/or an email address.

In one embodiment, the strength of connection may be based on presence of personalized information for the target individual in the contact entry.

In one embodiment, the personalized information may include a nickname for the target individual, a home address for the target individual, a personal email address for the target individual, and a birthday for the target individual.

In one embodiment, the strength of connection to the target individual may be further based on a type of meetings and communications with the target individual, a volume of meetings and communications with the target individual, and/or common engagements with the target individual.

In one embodiment, the common engagements may be retrieved from a public database.

In one embodiment, the type of meetings and communications with the target individual and/or the volume of meetings and communications with the target individual may be retrieved from a customer relationship management system.

In one embodiment, the strength of connection to the target individual may be determined using an algorithm comprising weightings determined using a machine learning engine.

In one embodiment, the plurality of contact entries may be retrieved from a contact management program or an email server.

According to another embodiment, a non-transitory computer readable storage medium may include instructions stored thereon, which when read and executed by one or more computer processors, cause the one or more computer processors to perform steps comprising: retrieving a plurality of contact entries from users within an organization; grouping the plurality of contact entries into a plurality of contact entry groupings, wherein each contact entry grouping may include at least one common attribute; receiving a query for one of the users having a contact entry with a target individual; identifying one of the contact entry groupings for the target individual based on the query; determining a strength of connection to the target individual for contact entries in the contact entry grouping; and returning an identification of the user with a highest strength of connection.

In one embodiment, the users may be employees of the organization.

In one embodiment, the common attribute may include a name, a phone number, and/or an email address.

In one embodiment, the strength of connection may be based on presence of personalized information for the target individual in the contact entry.

In one embodiment, the personalized information may include a nickname for the target individual, a home address for the target individual, a personal email address for the target individual, and a birthday for the target individual.

In one embodiment, the strength of connection to the target individual may be further based on a type of meetings and communications with the target individual, a volume of meetings and communications with the target individual, and/or common engagements with the target individual.

In one embodiment, the common engagements may be retrieved from a public database.

In one embodiment, the type of meetings and communications with the target individual and/or the volume of meetings and communications with the target individual may be retrieved from a customer relationship management system.

In one embodiment, the strength of connection to the target individual may be determined using an algorithm comprising weightings determined using a machine learning engine.

In one embodiment, the plurality of contact entries may be retrieved from a contact management program or an email server.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for management of customer relationship management contact entries according to an embodiment;

FIG. 2 illustrates a method for management of customer relationship management contact entries according to an embodiment;

FIG. 3 depicts an exemplary computing system for implementing aspects of the present disclosure.

### DETAILED DESCRIPTION OF PREFERRED EMBODIMENTS

Embodiments relate to systems and methods for management of customer relationship management contact entries. The term customer includes institutions, firms, corporates, governmental agencies, non-governmental agencies, organizations etc.

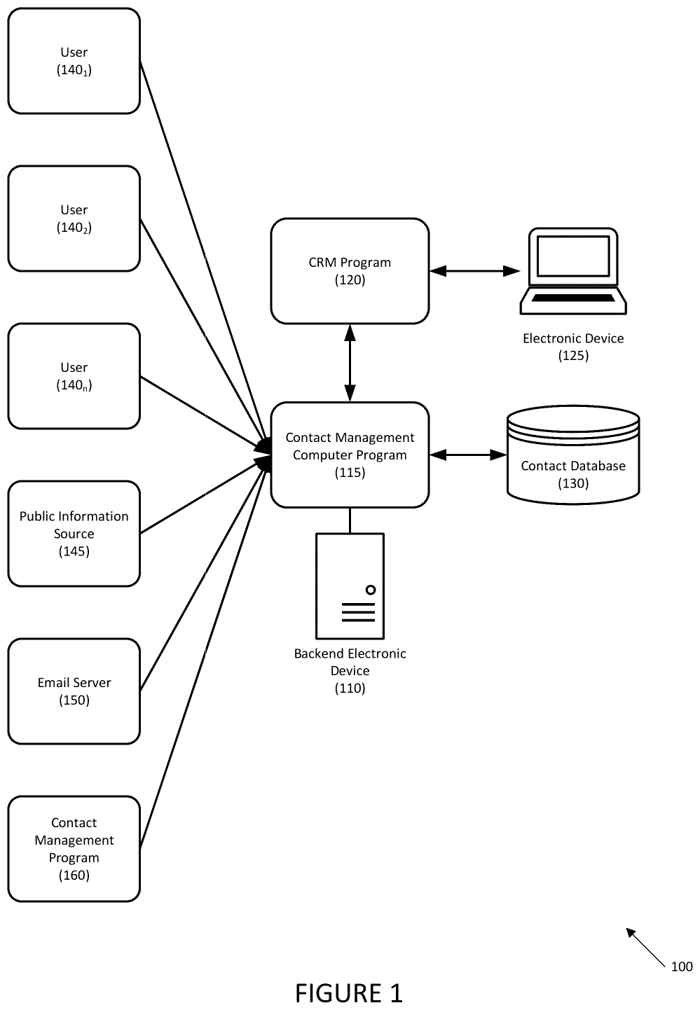

Referring to FIG. 1, a system for management of customer relationship management contact entries is disclosed according to an embodiment. System 100 may include backend electronic device 110, which may be a server (e.g., physical and/or cloud based), a computer (e.g., workstation, desktop, laptop, notebook, tablet, etc.), etc. Electronic device 110 may execute one or more computer programs or applications, such as contact entry management computer program 115.

Contact entry management computer program 115 may receive data from a plurality of users 140 (e.g., user 140₁, user 140₂, . . . , user 140ₙ) within an organization, including the user's contact entries for individuals. Users 140 may include employees of the organization or non-employees (e.g., vendors, contractors, etc.). For example, contact entry management computer program 115 may retrieve contact entries from email server 150 for the organization, from electronic devices (not shown) for users 140, from a contact entry management program 160, from publicly available information sources 145, such as social media sites, etc.

In one embodiment, each user 140's contact entries may include different information, such as different names (e.g., formal names, nicknames, etc.), email addresses (e.g., work email addresses, personal email addresses, stale email addresses, etc.), phone numbers (e.g., work phone numbers, personal phone numbers, stale phone numbers), employer (e.g., current employer, secondary employer, stale employer, etc.), job titles (e.g., primary job title, secondary job title, unofficial job titles, stale job titles, etc.), addresses (e.g., business address, home address, etc.), important dates (e.g., birthdays, anniversaries, etc.), and other pertinent client information such as social media IDs, virtual video conferencing IDs etc.

Contact entry management computer program 115 may group the different contact entries into contact groups based on one or more common attributes (e.g., name, phone number, email address, employer, job title, etc.). This is because different users 140 may have different information for common contact entries. Contact entry management computer program 115 may store the contact entry groupings in, for example, contact database 130.

Each user 140 may have access to only its contact entries and may not have access to the other versions of the contact in the group unless special permission is given.

In one embodiment, CRM program 120 may interface with contact entry management computer program 115. In one embodiment, contact entry management computer program 115 may be a separate program from CRM program 120, or it may be part of CRM program 120.

User 140 may query CRM program 120 for an individual within user 140's organization that has, or had, a relationship with a target individual by entering the target individual's name into an application, a browser, a computer program, etc. executed by electronic device 125. In one embodiment, contact entry management computer program 115 may identify a grouping of contact entries for the target individual, and may then score the strength of relationship between the individual having the contact and the target individual. For example, contact entry management computer program 115 may identify a target individual that matches the query and may assess the strength of relationship between each individual in the contact group and the target individual based on the presence of personalized information in the contact. Examples of personalized information may include the presence of the target individual's nickname instead of formal name, the presence of the target individual's home address, the presence of the target individual's personal email address, the presence of the target individual's mobile phone number, the presence of important dates (e.g., the target individual's birthday, anniversary, etc.), etc.

The automated scoring method may also be based upon the frequency of physical meetings, virtual meetings, emails, telephone/video calls, etc., as well as the manner in which those meetings and communications took place. For example, one on one meetings, phone calls, emails, etc. may indicate a stronger connection than a group meeting, phone call, or email. In another embodiment, the automated scoring may consider common previous employment, schooling, and other engagements (e.g., non-profit boards) between the individual and the target individual. This information may be received from CRM program 120.

In one embodiment, the CRM program 120 and/or contact entry management computer program 115 may access public information source(s) 145 that may be likely to be current (e.g., LinkedIn, BoardEx, etc.) to identify current jobs, titles, employers, etc. to assess whether any information is stale.

Contact entry management computer program 115 may score each employee's strength of relationship using an algorithm that may assign a weight to these and other factors. In one embodiment, the weights may be determined using a machine learning algorithm based on feedback on user relationship scores, historical recommendations, etc.

In one embodiment, user 140 may override its strength of relationship score as needed. For example, a contact may not include information that indicates a strong strength of relationship may override the score if user 140 has a strong relationship and has not included certain information in the contact. Conversely, user 140 may lower its score if the employee has certain information but does not have a strong relationship.

In embodiments, all users 140 may be able to see basic information, for example, name, source, and company name of every contact in the system, they may be presented with redacted information for certain type of information (e.g., mobile phone number, home address, etc.), or an indication as to whether this information is present. In embodiments, users 140 may allow their redacted contact entries to be shared as un-redacted information with other users 140. For example, users 140 in the same group may grant permission to each other to share their full contact information with each other.

Contact entry management computer program 115 may return a score (e.g., 1-5, 0-100, or any other suitable scale) and may provide backup for the score, such as an identification of the type of information that is present or not present in the contact that impacted the score. Users 140 may also be presented with the impact that the presence or absence of certain information had on the score.

In another embodiment, certain users may be provided with the information present that impacted the score.

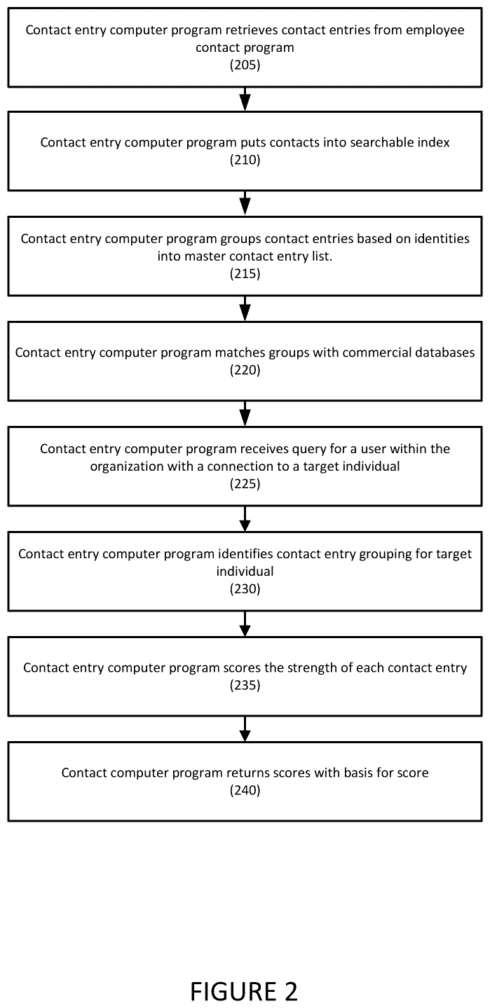

An example process is disclosed in FIG. 2.

In step 205, a computer program, such as a contact computer program, may retrieve contact entries from users, such as employees, within an organization.

In step 210, the computer program may optionally organize the contact entries into a searchable index. For example, the computer program may alphabetize the contact entries.

In step 215, the computer program may create groups of contact entries based on common attributes. For example, the computer program may group the different contact entries based on name, phone number, email address, employer, job title, etc., and may then store the groupings in a contact database.

Note that a contact entry grouping may include a single contact if there are no other contact entries within the organization.

In step 220, the contact computer program may optionally match the contact groups with contact information in one or more commercial databases that may be considered to be current.

In step 225, the computer program may receive a query for a user within an organization that has a connection to a target individual. For example, the computer program may receive a target individual's name, email address, organization, or any other identifying information.

In one embodiment, the information may be received in an electronic form, and the user may provide as much information as the user has.

In step 230, the computer program may retrieve a contact entry grouping for the target individual. For example, the computer program may match the information provided in the query to one or more contact entry groupings, if available.

In step 235, the computer program may score the strength of each contact with the target individual. For example, the computer program may review each contact and may assess the strength based on one or more of the name (e.g., the presence of a nickname), an address (e.g., the presence of a home address), an email address (e.g., the presence of a personal email address), a phone number (e.g., the presence of a mobile phone number, direct phone number, important dates (e.g., the presence of a birthday, anniversary, etc.), family information (e.g., the presence of spouse information, child information, etc.), etc. The computer program may further consider the recency of any updates to the contact.

The computer program may also consider the frequency of physical meetings, virtual meetings, emails, telephone/video calls, etc., as well as the manner in which those meetings and communications took place. For example, one on one meetings, phone calls, emails, etc. may indicate a stronger connection than a group meeting, phone call, or email. In another embodiment, the automated scoring may consider common previous employment, common schooling, and other common engagements (e.g., non-profit boards) between the individual and the target individual. This information may be retrieved from, for example, a CRM system, public information sources (LinkedIn, FaceBook, BoardEx, etc.), etc.

In one embodiment, the computer program may assign each attribute a weighting, and may use the weightings to generate a score. The weightings may be set using machine learning based on prior queries, and the results of those queries.

In step 240, the computer program may return an identification of one or more users having a connection with the target individual, and the score. In one embodiment, only the user having the highest score may be returned; in another embodiment, some or all of the users having a contact entry for the target individual, and their scores may be returned.

In one embodiment, the computer program may provide the contact information for the user (e.g., phone number, email address, office location, etc.), may generate an introductory email from the source of the query to the user, etc.

In one embodiment, depending on the preferences of the user having the contact, the computer program may return certain details for the target individual. For example, the computer program may only return public information unless the user with the contact elects to share non-public information (e.g., personal email address, mobile phone number, etc.).

The computer program may also provide a basis for the score, such as the type of information that was present or not present in the contact, information on types of contact entries from the CRM system, etc.

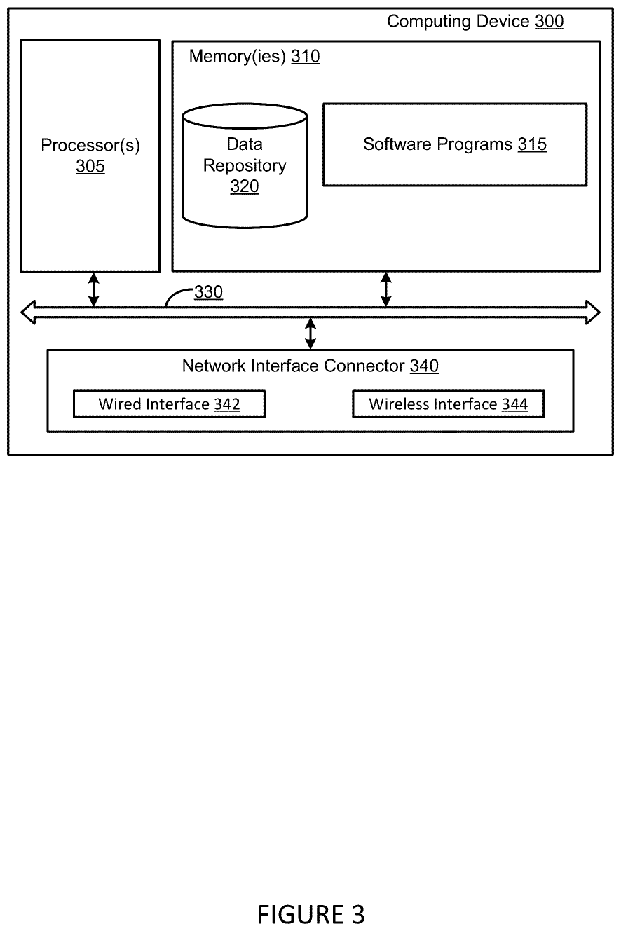

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as programmatic instructions, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Additional details may be found in the attached Appendix, the disclosure of which is hereby incorporated, by reference, in its entirety.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope. Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
retrieving, by a computer program, a plurality of contact entries from users within an organization;
grouping, by the computer program, the plurality of contact entries into a plurality of contact entry groupings, wherein each contact entry grouping comprises at least one common attribute;
receiving, by the computer program, a query for one of the users having a contact entry with a target individual;
identifying, by the computer program, one of the contact entry groupings for the target individual based on the query;
determining, by the computer program, a strength of connection to the target individual for contact entries in the contact entry grouping; and
returning, by the computer program, an identification of the user with a highest strength of connection.

2. The method of claim 1, wherein the users are employees of the organization.

3. The method of claim 1, wherein the common attribute comprises a name, a phone number, and/or an email address.

4. The method of claim 1, wherein the strength of connection is based on presence of personalized information for the target individual in the contact entry.

5. The method of claim 4, wherein the personalized information comprises a nickname for the target individual, a home address for the target individual, a personal email address for the target individual, and a birthday for the target individual.

6. The method of claim 1, wherein the strength of connection to the target individual is further based on a type of meetings and communications with the target individual, a volume of meetings and communications with the target individual, and/or common engagements with the target individual.

7. The method of claim 6, wherein the common engagements are retrieved from a public database.

8. The method of claim 6, wherein the type of meetings and communications with the target individual and/or the volume of meetings and communications with the target individual are retrieved from a customer relationship management system.

9. The method of claim 1, wherein the strength of connection to the target individual is determined using an algorithm comprising weightings determined using a machine learning engine.

10. The method of claim 1, wherein the plurality of contact entries are retrieved from a contact management program or an email server.

11. A non-transitory computer readable storage medium, including instructions stored thereon, which when read and executed by one or more computer processors, cause the one or more computer processors to perform steps comprising:
retrieving a plurality of contact entries from users within an organization;
grouping the plurality of contact entries into a plurality of contact entry groupings, wherein each contact entry grouping comprises at least one common attribute;
receiving a query for one of the users having a contact entry with a target individual;
identifying one of the contact entry groupings for the target individual based on the query;
determining a strength of connection to the target individual for contact entries in the contact entry grouping; and
returning an identification of the user with a highest strength of connection.

12. The non-transitory computer readable storage medium of claim 11, wherein the users are employees of the organization.

13. The non-transitory computer readable storage medium of claim 11, wherein the common attribute comprises a name, a phone number, and/or an email address.

14. The non-transitory computer readable storage medium of claim 11, wherein the strength of connection is based on presence of personalized information for the target individual in the contact entry.

15. The non-transitory computer readable storage medium of claim 14, wherein the personalized information comprises a nickname for the target individual, a home address for the target individual, a personal email address for the target individual, and a birthday for the target individual.

16. The non-transitory computer readable storage medium of claim 11, wherein the strength of connection to the target individual is further based on a type of meetings and communications with the target individual, a volume of meetings and communications with the target individual, and/or common engagements with the target individual.

17. The non-transitory computer readable storage medium of claim 16, wherein the common engagements are retrieved from a public database.

18. The non-transitory computer readable storage medium of claim 16, wherein the type of meetings and communications with the target individual and/or the volume of meetings and communications with the target individual are retrieved from a customer relationship management system.

19. The non-transitory computer readable storage medium of claim 11, wherein the strength of connection to the target individual is determined using an algorithm comprising weightings determined using a machine learning engine.

20. The non-transitory computer readable storage medium of claim 11, wherein the plurality of contact entries are retrieved from a contact management program or an email server.
